(19) United States
(12) Patent Application Publication
(10) Pub. No.: US 2006/0290901 A1
(43) Pub. Date: Dec. 28, 2006

(54) Light shielding heat-resistant sheet material, and light amount regulating apparatus and projector apparatus utilizing the same

(75) Inventors: Masahiko Moriyama, Osaka (JP); Sumio Takeuchi, Koufu-shi (JP)

Correspondence Address: KANESAKA BERNER AND PARTNERS LLP, SUITE 300, 1700 DIAGONAL RD, ALEXANDRIA, VA, 22314-2848, US

(73) Assignees: CAM CO., LTD., Osaka-shi (JP); NISCA CORPORATION, Minamikoma-gun (JP)

(21) Appl. No.: 11/358,151

(22) Filed: Feb. 22, 2006

(30) Foreign Application Priority Data
Jun. 23, 2005 (JP) 2005-184096

(51) Int. Cl. G03B 21/14

(52) U.S. Cl. 353/97

(57) ABSTRACT

A light shielding heat-resistant sheet material has a film substrate sheet of a polyethylene naphthalate resin and/or a polyimide resin, and a two-component curable polyester resin paint coated on one or both surfaces of the film substrate. The two-component curable polyester resin paint has a polyester resin as a principal agent, an isocyanate compound as a curing agent, and a black pigment. The sheet material can be used as a blade member in a light amount regulating apparatus to be incorporated in an optical equipment, such as a projector. The blade member resists deformation by heat and has reduced weight, and thereby enables secure light amount regulation while operating smoothly and quietly.

### BACKGROUND OF THE INVENTION AND RELATED ART STATEMENT

The present invention relates to a light-shielding heat-resistant sheet material adapted for use as a blade member of a light amount regulating apparatus, to be mounted on a projector apparatus in which an image formed by image forming means such as a cathode ray tube or a liquid crystal panel is irradiated with a light from a light source and is projected onto a screen through a projection lens or the like.

Such a projector apparatus is well known as an apparatus in which an image such as a character image or a picture image, formed by an image forming part such as a Braun tube (CRT) or a liquid crystal panel, is irradiated with a light from a light source such as a halogen lamp and projected onto a screen through a projection lens. It is utilized for various presentations for projecting a still image such as a character image on a screen and for a rear-projection television or a home theater for projecting a moving picture image on a screen.

In the application for a rear-projection TV or a home theater requiring a wide luminance range for example in a movie viewing, an image of a deeper impression can be obtained by suitably regulating the light amount depending on the image to be viewed, for example by rendering a dark scene even darker and a bright scene even brighter thereby achieving an increased contrast.

Also in a case where consecutive image frames as in a moving image show large changes in the luminance, for example in a moving image in which every image frame is changed in a time less than a tenth of a second, a large change in the image luminance gives a fatigue in the eyes of the observer and a stimulation by the light, thus inducing a detrimental influence on the physical condition of the observer. It is therefore necessary to regulate the light amount in every frame of the continuous image so as to relax the stimulation given to the eyes of the user.

For such light amount regulation, as described in JP-A-2003-241311, in a structure of separating a light from a light source by dichroic mirrors into three primary colors R, G and B for irradiating image forming panels such as liquid crystal panels, a light amount regulating diaphragm apparatus is provided between the light source and the dichroic mirrors. In the projector apparatus described in this reference, a light from a light source lamp is separated by a light separator such as dichroic mirrors into the three primary colors or R, G and B, which are respectively directed to image forming panels, constituted of liquid crystal panels, and the lights transmitted by the panels are united and projected by a projection lens onto an external screen.

As image forming means, there are for example known, in addition to the liquid crystal panel, a method of showing a scanning line image by a Braun tube (CRT projector) and a digital imaging method of converting light beams of three primary colors of R, G and B into scanning beams by micromirrors (digital light processing projector). The light amount regulating diaphragm apparatus has a substrate with an optical aperture of which an optical center is positioned on an optical path from the light source to the mirrors, and is provided with plural blades which are overlaid in succession, and rendered respectively rotatable on a rim of the optical aperture.

The blades are mounted at a predetermined pitch on the rim of the optical aperture in such a manner that the contours thereof are mutually overlaid as in fish scales and the distal end of each blade faces the optical aperture, and the optical aperture can be covered with a variable aperture size by rotating the blades about the proximal ends thereof. Such structure is widely known as a light amount regulating apparatus for a camera or the like.

Such structure for light amount regulation utilizing a blade member positioned at the optical aperture, known for example in a photographing apparatus such as a camera, results in the following problems when employed in a projection apparatus such as a projector.

In the projector apparatus, as a light from a light source lamp irradiates an image forming device for projecting an image formed therein onto a screen, the heat of the light source lamp affects the blade member positioned between the lamp and the image forming device. Particularly in a recent projector apparatus for which a high illumination intensity and a compactness are required and which employs a high-intensity metal halide lamp or a high-pressure mercury lamp, a temperature as high as about 200° C. is reached in the proximity of the lamp. For this reason, the blade member formed by a thin plate of a metal such as stainless steel shows a large operational load in the operation because of the weight of the blade, thus generating spots in operation. Also the blade member formed by metal thin plates generates a large metal noise by the mutual friction of the blades.

Also when a rolled metal material formed by stainless steel is punched and formed into a blade shape and assembled in the projector apparatus, a distal part of the blade facing the optical aperture is bent and deformed as shown in FIGS. 12A-12C, thereby hindering a smooth operation and eventually leading to a mutual entanglement of the blades, thus disabling the light amount regulation.

In consideration of the foregoing, an object of the present invention is to provide a light shielding heat-resistant sheet material adapted for use as a blade member of a light amount regulating apparatus to be incorporated in optical equipment involving a high temperature such as a projector, capable of suppressing a deformation of the blade member by heat and reducing the weight of the blade member, thereby enabling a secure light amount regulation by a smooth operation with a low operation noise, and a light amount regulating apparatus and a projector apparatus utilizing such sheet material.

Further objects and advantages of the invention will be apparent from the following description of the invention and the associated drawings.

### SUMMARY OF THE INVENTION

For attaining the aforementioned object, the present invention provides a light shielding heat-resistant sheet material formed by providing a film substrate of a polyethylene naphthalate resin and/or a polyimide resin, on a surface or on both surfaces thereof, with a cured layer of a two-component curable polyester resin paint containing a polyester resin cured with an isocyanate compound and a black pigment.

The light shielding heat-resistant sheet material is formed by employing carbon black as the black pigment, and by coating one or both surfaces of the film substrate with the two-component curable polyester resin paint in a state where the polyester resin (polyols as the main component and the like), the isocyanate compound and the carbon black are mixed.

Also in the light shielding heat-resistant sheet material of the invention, xylylene diisocyanate (XDI) may be employed as the isocyanate compound.

The present invention also provides a light amount regulating apparatus including a substrate having an optical aperture, a blade member for regulating a light amount passing through the optical aperture, and drive means which opens or closes the blade member, in which the above-mentioned light shielding heat-resistant sheet material is used as the blade member.

The present invention further provides a projector apparatus in which the light amount regulating apparatus is provided between a light source of the projector apparatus and projection means which projects a light from the light source onto a screen through an image forming panel, or on the projection means.

### BRIEF DESCRIPTION OF THE DRAWINGS

FIGS. 1A and 1B are explanatory views showing constitutions of a light shielding heat-resistant sheet material of the present invention;

FIGS. 2A and 2B are views showing a state of a coating film in the light shielding heat-resistant sheet material of the present invention;

FIG. 3 is a view showing a manufacturing process of the coating film in the light shielding heat-resistant sheet material of the present invention;

FIG. 4 is an explanatory view showing a system constitution of a projector apparatus of the present invention;

FIG. 5 is a schematic view showing a constitution of a projector apparatus of the present invention;

FIG. 6 is a view showing a layout of a light amount regulating apparatus of the present invention;

FIG. 7 is an exploded perspective view of the apparatus shown in FIG. 6;

FIG. 8 is a lateral cross-sectional view of the apparatus shown in FIG. 7;

FIGS. 9A and 9B are respectively a lateral cross-sectional view showing an assembled state of the light amount regulating apparatus of the invention, and a magnified partial view thereof;

FIGS. 10A, 10B, and 10C are perspective views respectively showing an overlaid state in a blade member; a shape of a blade member; and a lateral cross-sectional view thereof;

FIG. 11 is a circuit diagram of a light amount regulating circuit for driving the light amount regulating apparatus of the present invention; and

FIGS. 12A, 12B, and 12C are views showing a blade member in a related-art light amount regulating apparatus, respectively showing an overlaid state of blade members; a shape of the blade member; and a lateral cross-sectional view of the blade member.

### DETAILED DESCRIPTION OF THE PREFERRED EMBODIMENTS

Now the present invention will be described in detail by embodiments with reference to the accompanying drawings.

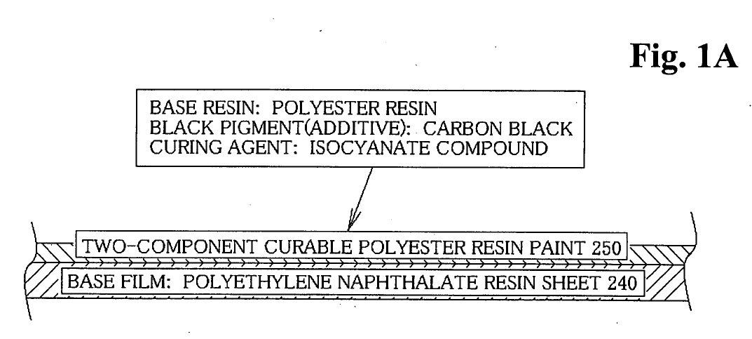

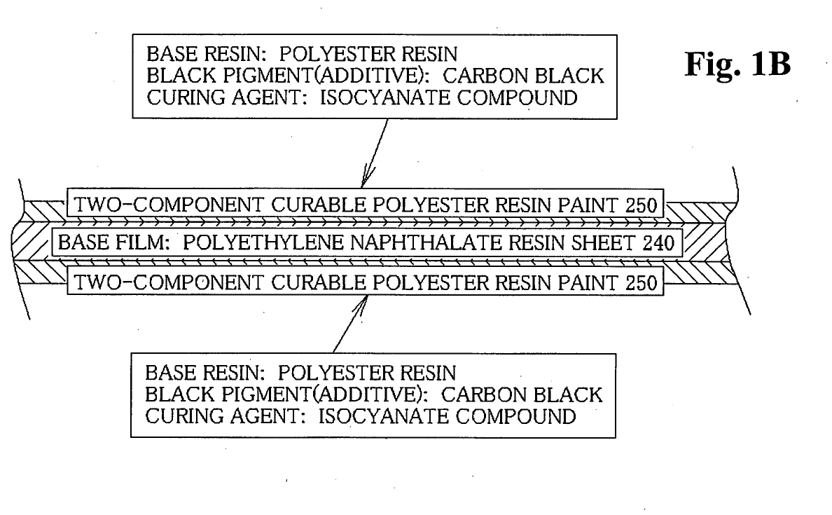

At first, a light shielding heat-resistant sheet material of the present invention will be explained with reference to FIGS. 1A and 1B. The light shielding heat-resistant sheet material is constituted, as illustrated, of a film substrate 240 of a polyethylene naphthalate resin formed in a sheet shape, and a cured layer 250 formed by coating and curing, on one surface (FIG. 1A) or on both surfaces (FIG. 1B) of the film substrate 240, a two-component curable polyester resin paint prepared by blending a polyester base resin (polyol), an isocyanate compound as a curing agent, and carbon black as a black pigment constituting a light-shielding additive, in an appropriate composition.

The isocyanate compound employed as the curing, agent blended in the two-component curable polyester resin paint provides a satisfactory adhesion between the polyethylene naphthalate substrate and the coated layer whereby the coated layer is not easily peeled off. Therefore, when the sheet material is employed as a blade member of a light amount regulating apparatus to be explained later, the coated layer can be prevented from peeling by a mutual friction of the blades in operation. Also, while an ordinary polyethylene naphthalate resin generally has a heat resistance of about 120° C., an isocyanate compound of an immediate function and resistant to yellowing, such as xylylene diisocyanate (XDI-type polyisocyanate), causes the two-component curable polyester resin to grow into a high-molecular polymer of a three-dimensional steric structure, which is used for covering the surface of the sheet-shaped substrate 240 of polyethylene naphthalate resin, thereby improving the heat resistant temperature of the resin to about 200° C. thereby obtaining a light shielding heat-resistant sheet material having a high heat resistance and a high film strength.

Also, by employing carbon black as a black pigment constituting a light-shielding additive, and coating the surface of the film substrate 240 with the two-component curable polyester resin paint 250 formed by a mixture of the polyester resin, isocyanate compound and carbon black, the following excellent characteristics can be obtained in comparison with a related-art technology utilizing a phenolic resin adhesive that has been employed as a common adhesive.

By employing an isocyanate compound as the curing agent for the two-component curable polyester resin paint 250 for coating the surface of the polyethylene naphthalate resin film substrate 240 and also employing carbon black as the black pigment constituting the light-shielding additive, the isocyanate compound constructs a crosslinked structure, involving carbon black, in the polyester resin system, whereby the carbon black can be added in a larger amount than in the related-art technology, to the polyester resin system.

Also, a larger content of carbon black provides a film having a satisfactory light-shielding property. Also, a plastic deformation of the polyester resin itself can be suppressed. Thus, a light shielding heat-resistant sheet material can be obtained having a heat resistance with a practical heat resistant temperature almost reaching a level of 250° C. by inducing a satisfactory thermal plastic deformation resistance, and also having a uniform distribution of carbon black and not easily generating spots in the light shield, by maintaining a particle size distribution of carbon black within a predetermined range prior to blending thereof.

The film substrate generally has a thickness of 5-500 μm, preferably 10-200 μm. The film substrate is formed by a polyethylene naphthalate resin and/or a polyimide resin, but other additive components may be added if necessary.

The two-component curable polyester resin paint is principally constituted of an isocyanate compound and a polyol, and in addition contains a black pigment as an essential component. Also a glycol, a diamine or the like employed as a chain extending agent may be added if necessary. The two-component curable paint, when cured, forms a polyester resin by the polyol and the isocyanate compound. Thus the cured layer contains the polyester resin and the black pigment.

The polyol can be, for example, polyethylene adipate, polybutylene adipate, polyhexamethylene adipate or polycaprolactone, and these may be employed singly or in a combination of two or more kinds.

The isocyanate compound is preferably a diisocyanate, such as xylylene diisocyanate, tolylene diisocyanate, 4,4′-diphenylmethane diisocyanate, hexamethylene diisocyanate, 4,4′-methylenebiscyclohexyl isocyanate or isophorone diisocyanate, which may be employed singly or in a combination of two or more kinds. It is preferably xylylene diisocyanate.

The black pigment can be those employed ordinarily in the paint field, but is preferably carbon black. An average particle size of carbon black is not particularly restricted, but is generally in a range of 0.005-0.05 μm, preferably 0.01-0.05 μm.

Blending amounts of polyol (principal agent) and isocyanate (curing agent) can be those ordinarily employed in the two-component curable polyester resin paint, but are reduced in relative manner when the black pigment is blended in a large amount. For example, the blending amounts can be 5-50 wt. % for polyol, 1-50 wt. % for isocyanate and 60-90 wt. % for the black pigment.

The chain extending agent can be a glycol such as ethylene glycol, 1,4-butanediol, 1,6-hexanediol or neopentyl glycol, or a diamine such as ethylene diamine, hexamethylene diamine or isophoronediamine.

Other additives include a coupling agent (such as a silane coupling agent or a titanium coupling agent), a tackifier (such as a terpene resin, a phenolic resin, a terpene-phenol resin, a rosin resin, or a xylene resin), a thixotropic agent (such as Aerosil or Disparlon), and a stabilizer (such as an ultraviolet absorber, an antioxidant, a thermal stabilizer, or an antihydrolysis stabilizer).

Blending amounts of the chain extending agent and other additives may be those ordinarily employed in the two-component curable polyester resins.

The two-component curable polyester resin paint containing these components is coated on a film-shaped substrate. The coating method is not particularly restricted and can be any method for coating a film-shaped substance with a paint, for example a roll coating, a brush coating or a spraying.

The paint, after being coated on the substrate, is dried according to the necessity thereby being cured. A thickness of the cured coating is not particularly restricted, but is usually 0.5-50 μm, preferably 8-15 μm.

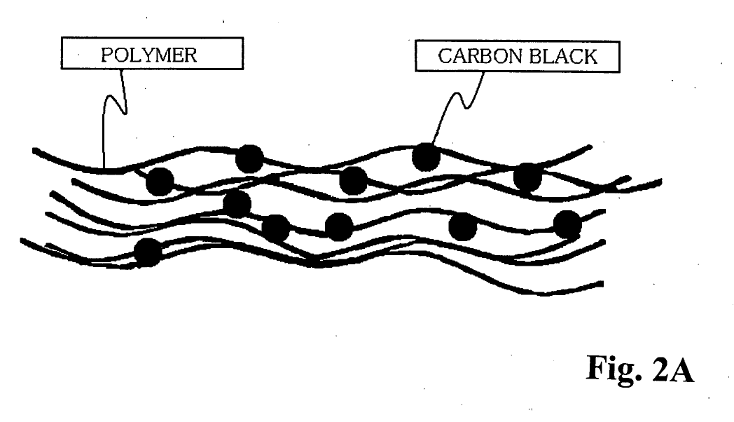

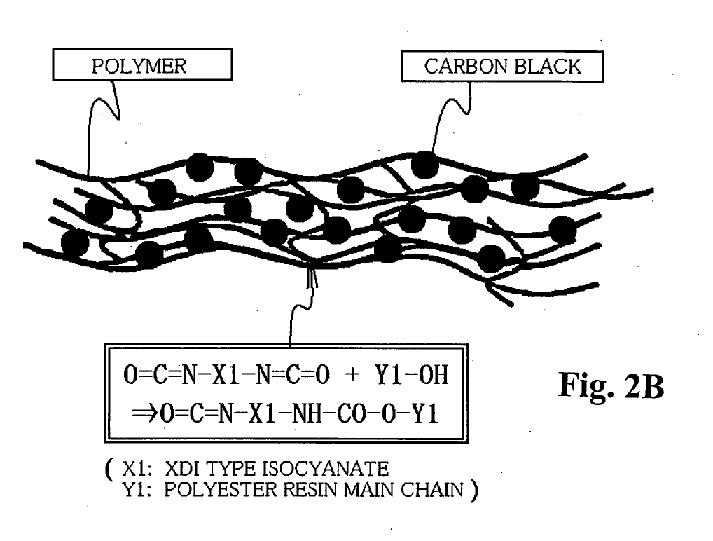

In the following, the function of the isocyanate compound will be explained. FIGS. 2A and 2B are schematic views showing the state of the two-component curable polyester resin paint 250, wherein FIG. 2A shows a state of an ordinary coating material employing for example a phenolic resin adhesive, while FIG. 2B shows a state of a coating material utilizing xylylene diisocyanate as the isocyanate compound.

As shown in FIG. 2A, the polymer molecules are superposed in plural layers in a mutually entangled state to form a film, and the carbon particles are incorporated randomly therein in a state pinched between such layers. In such state, a side chain or an end portion of the polymer molecule engage with fine irregularities or pores of the carbon particle (anchoring effect), and an extremely shortened distance between the polymer molecules or between the polymer molecule and the carbon particle surface effectively induces an intermolecular force (van derWaals' force) thereby providing a film forming ability and a film strength. Also, the carbon particles in this state exert a skeletal function of binding the film in the vertical direction and supporting the polymer molecules undergoing a plastic deformation. However, though very large effects can be obtained by the carbon particles under an optimum amount of addition, such effects are inverted when the amount of the carbon particles is increased to raise the light shielding property beyond the optimum amount of addition, and the skeletal function of the carbon particles hinders the mutual binding of the polymer molecules, thereby eventually deteriorating the film forming ability.

In contrast, in the case of employing an isocyanate compound, preferably xylylene diisocyanate as shown in FIG. 2B, it is rendered possible to cause a chemical bonding of “—OH” present in the base polyester polymer molecule, thereby constructing a three-dimensionally steric film linked in the vertical, horizontal and diagonal directions, in contrast to the state shown in FIG. 2A in which plural layers are superposed like ground strata. A chemical bond between “—OH” and “—NCO” causes the molecules to be mutually entangled and provides an interatomic adhesion far stronger than an intermolecular force (van der Waals' force).

Also such a three-dimensional strong structure enables the incorporation of a larger amount of carbon particles within the film and allows, at the same time, obtaining the “anchoring effect,” “van derWaals' force,” and “auxiliary skeletal function” mentioned above, thereby obtaining a film capable of containing a larger amount of carbon black therein, and excellent in the light shielding effect by carbon black.

A crosslinking by isocyanate causes a chemical bonding between hydroxyl groups “—OH” in the base polyester resin, ideally all groups, and two “—NCO” groups of xylylene diisocyanate, thereby changing:
[O═C═N—X1—N═C═O]+[Y1—OH]
into
[O═C═N—X1—NH—CO—O—Y1],
wherein X1 indicates an XDI type isocyanate and Y1 indicates a main chain of the polyester resin.

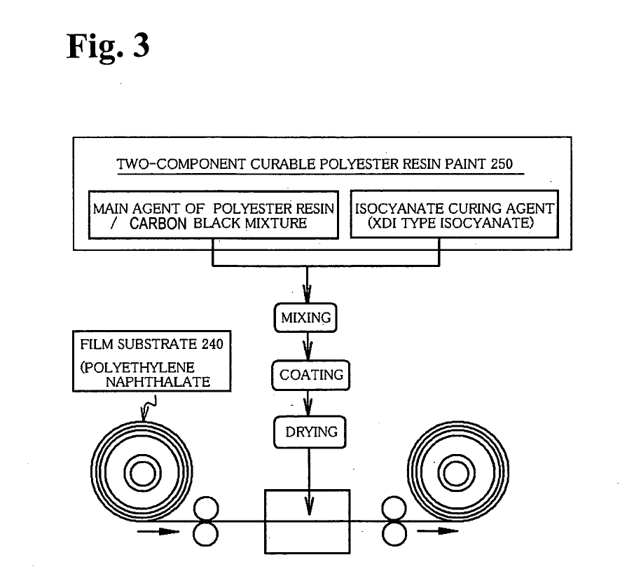

In the following, a manufacturing process for the two-component curable polyester resin paint 250 will be briefly explained with reference to FIG. 3. At first, a base polymer of a base polyester resin is prepared. Then this base polymer is formed into a paint with a solvent, and carbon black is mixed in an appropriate amount for obtaining the light shielding property, thereby obtaining a principal agent. Then an isocyanate compound as the curing agent, preferably xylylene diisocyanate, is mixed at the coating onto the film substrate 240, obtained by forming a polyethylene naphthalate resin into a sheet.

The coating process is executed by unwinding the film substrate 240, coating the two-component curable polyester resin paint 250 on the surface thereof, then removing the solvent in the coating material in a drying oven and re-winding the substrate.

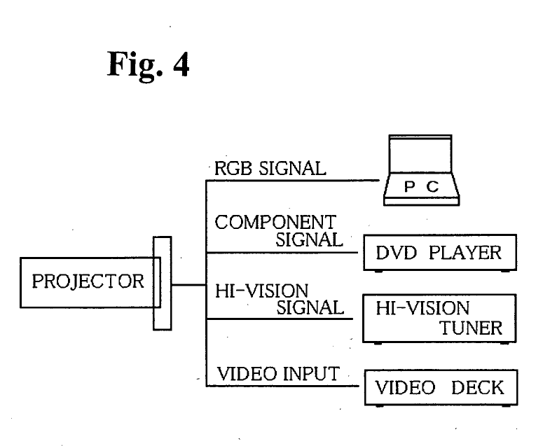

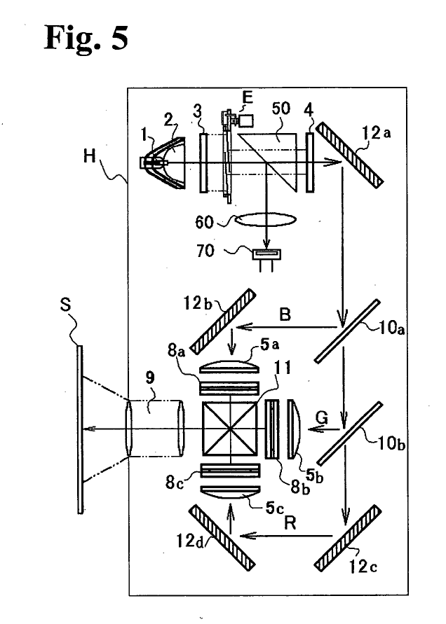

In the following, a light amount regulating apparatus and a projector apparatus, employing the light shielding heat-resistant sheet material as a blade member therein, will be explained. FIG. 4 is a schematic view showing a system configuration thereof, and FIG. 5 is a schematic view showing an internal structure of the projector apparatus.

An image can be inputted into the projector apparatus for example by an RGB signal, a component signal, a hi-vision signal or a video signal. The RGB signal is transferred to the projector for example from an image output terminal of a computer. Also the component signal, the hi-vision signal or the video signal is transferred to the projection respectively from an output terminal of a DVD player, a tuner for a hi-vision TV or a video deck. Such projector apparatus is known in various types, and FIG. 5 shows, as an example, a layout employing a liquid crystal panel as the image forming part (image forming means).

FIG. 5 illustrates a projector apparatus H and a screen S for projecting an image. The projector H is provided with a projection light source 1, utilizing for example a metal halide lamp, a high-pressure mercury lamp, an NSH lamp, a xenon lamp or a VIP lamp. A light emitted from the light source 1 is reflected by a parabolic reflector 2 as a substantially parallel light beam, then subjected to an elimination of unnecessary infrared and ultraviolet lights by a filter 3, formed by a lens array constituting an integrator lens, and is subjected to a light amount regulation to an optimum intensity by a light amount regulating apparatus E. Then the light passes an integrator lens 4 for improving a condensing efficiency on the liquid crystal panel and a peripheral light amount ratio, and is substantially perpendicularly folded by a mirror 12a. The light is then separated into the three primary colors R, G and B by separating mirrors. At first a B light, separated by reflection by a dichroic mirror 10a which transmits G and R lights and reflects the B light, is guided by a mirror 12b to a condensing lens 5a for forming a parallel light beam, then transmitted by a liquid crystal panel 8a and reaches a synthesizing prism 11 as a B image.

Also the G and R lights transmitted by the first dichroic mirror 10a are separated by a second dichroic mirror 10b which transmits the R light and reflects the G light, and the G light thus separated by reflection condensed into a parallel light beam by a condensing lens 5b, then transmitted by a liquid crystal panel 8b and reaches the synthesizing prism 11 as a G image. Also the R light, transmitted by the second dichroic mirror 10b, is guided by two mirrors 12c, 12d to a condensing lens 5c for forming a parallel light beam, then transmitted by a liquid crystal panel 8c and reaches a synthesizing prism 11 as an R image. The synthesizing prism 11 synthesizes the three primary colors R, G and B into a single color image which is guided to a projection lens 9 and is projected in a suitably enlarged size onto a screen S in front.

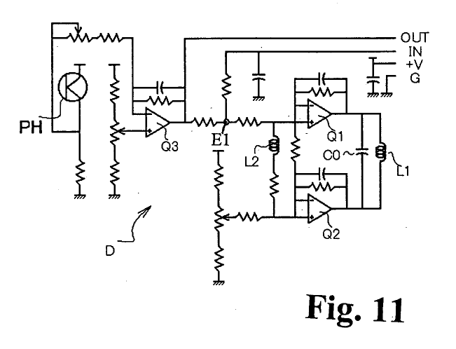

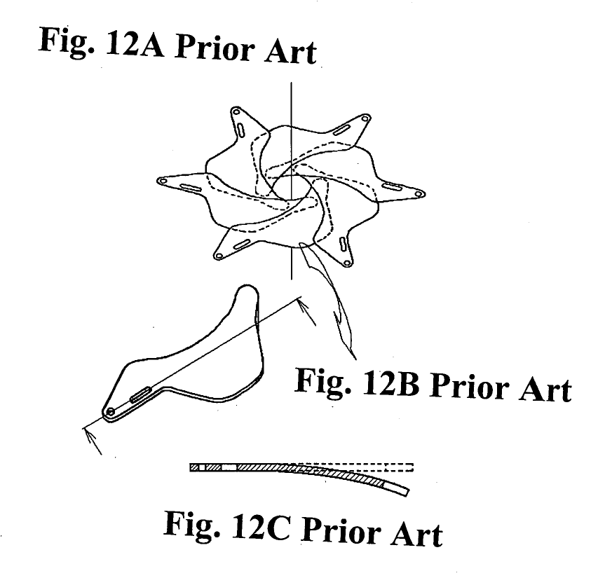

Also the light regulated to an appropriate intensity by the light amount regulating apparatus E is separated partly by a half mirror (or a dichroic mirror) 50, and the separated light is received by a photosensor (for example a photodiode) 70 through a condensing lens 60. An output signal of the photosensor (for example a photodiode) 70 is fetched as a direct light amount at the detection by a light amount regulating circuit shown in FIG. 11, and a CPU of the main body of the apparatus compares it with an appropriate light amount and controls the light amount regulating apparatus E based on the result of comparison, thereby suppressing an aberration by a temperature change and executing an appropriate light amount regulation.

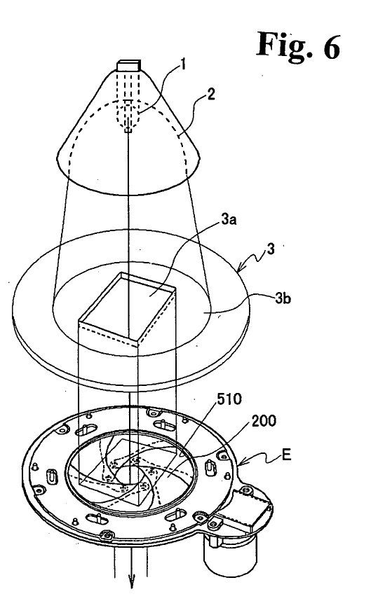

Then a relative positioning of the light source 1, the filter 3 and the light amount regulating apparatus E with reference to FIG. 6, which illustrates a light source 1, a reflector 2, a filter 3 and a light amount regulating apparatus E. A light beam emitted from the light source 1, reflected and condensed by the reflector 2, irradiates the filter 3 as illustrated. The filter 3 cuts off infrared and ultraviolet lights as explained above, and is provided with a light-transmitting rectangular area 3a in a central part, defined by a reflective surficial coating provided outside such rectangular area. Therefore the light from the light source 1 irradiates the light amount, regulating apparatus E, after cutting off, by the rectangular area 3a, of a peripheral light unnecessary for the projection on the screen. The light amount regulating apparatus E has an optical aperture 510, which is larger than an aperture when the blade member 200 is fully open, and a, fully open aperture of the blade member 200 is selected to be smaller than the transmitting rectangular area 3a.

Then the light amount regulating apparatus E, which is to be positioned in the optical path from the light source 1 to the integrator lens 4 through the filter 3, will be explained.

The light amount regulating apparatus E is constituted of a substrate (500 as explained later) having an optical aperture 510 for transmitting the light from the light source 1, blades 200 mounted on the substrate 500 in such a manner that distal ends thereof are positioned at the optical aperture 510, a transmission member 400 for opening/closing the blades 200, and drive means 700 which actuates the transmission member 400.

At first the blade member 200 will be explained. The blade member 200 is positioned at the optical aperture 510 and varies the size of the aperture, thereby regulating the passing light amount. Therefore the blade member 200 is formed by a flat plate member so as to cross the aperture formed on the substrate, and is rotatably mounted at a proximal end thereof articulated on a periphery of the aperture on the substrate, or supported by a guide member so as to be slidably movable. The blade member 200 is formed by punching a film-shaped synthetic resinous material into an appropriate shape, and employs a material showing little change by heat, as the light source lamp of the projector apparatus reaches a temperature as high as 200° C. as described above.

The blade member 200 illustrated in FIGS. 6-10C is formed by the aforementioned light shielding heat-resistant sheet material, capable of withstanding the high temperature from the light source 1, as it is capable of attaining a significant weight reduction in comparison with the related-art metal blade, a resistance to the high temperature without a deformation by a heat-resistant effect, and an adequate light amount regulation by a smooth operation in the light amount regulating apparatus.

It has an oblong shape of which a proximal end is supported on the substrate and a distal end is positioned at the optical aperture 510, and the distal end portion is so shaped as to vary the aperture area at a predetermined-design value.

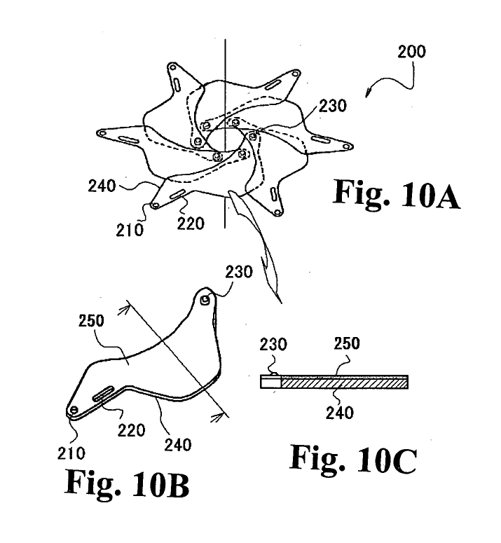

In case of employing a single blade, a circular hole is formed in the distal end portion, and is used for regulating the light amount. In case of employing two blades, a semi-circular hole is formed in the distal end portion of each blade member, and the blade members are rotated in mutually opposite directions to vary the hole size. In case of employing three or more blades, they are provided at a constant pitch on the periphery of the optical aperture 510, in such a manner that the rims of the adjacent blades are mutually overlaid. In the illustrated example, six blades 200 are overlaid in succession as shown in FIG. 10A, thereby forming a substantially circular aperture at the center of the distal ends of the blades. Also each blade is provided, at a proximal end thereof, with a fitting hole 210 for fitting with a supporting pin 530 of the substrate to be explained later, and a slit hole 220 for engaging with a transmission member 400.

Also the illustrated blade 200 has a projection 230 in the distal end portion to be mutually overlaid, in order to reduce a friction between the mutually overlaying blades thereby reducing the operation noise at the opening/closing operation and enabling a smooth operation with a low driving power.

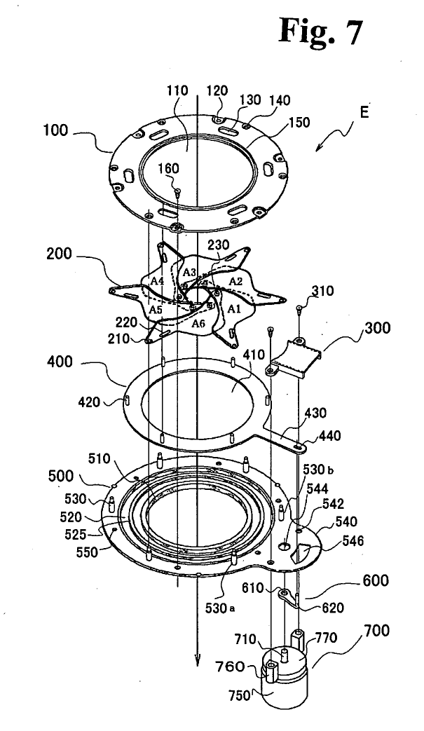

In the following, a substrate and a blade-driving mechanism will be explained with reference to FIG. 7.

The blades 200 are supported between a pair of mutually opposed substrates, and regulate a diameter of an optical aperture formed therein. The substrate is constituted of a base plate 500 and a pressing plate 100, and the base plate 500 supports a transmission member 400 for opening/closing the blades and a driving motor 700. Thus the substrate (hereinafter referred to as base plate) of an appropriate shape such as a circular shape, the blade members 200, the transmission member 400 for open/closing the blade members 200 and the driving motor 700 for driving the transmission member 400 are mounted, and then the pressing plate 100 is mounted on the base plate 500. Consequently the above-mentioned components are accommodated and supported between the base plate 500 and the pressing plate 100.

The base plate 500 is provided with an optical aperture 510 at the center, a recessed groove 520 on a concentric circle around the optical aperture 510, and a projecting guide rail 525 provided on the bottom of the groove, for rotatably supporting the transmission member 400. It is further provided with supporting shafts 530, provided in equally divided positions on a further outside concentric circle and constituting rotary centers for the blade members 200, screw holes 550 provided respectively close to the supporting shafts 530 for screwing the pressing plate 100 in positions not hindering the function of the light amount regulating means (blade members) 200, and an outward extended support portion 540 which is provided with a fixing hole 542 and an enlarged hole 544 for supporting the driving motor 700 and a sector-shaped slit 546 to be penetrated by an actuating pin 620 of an actuation lever 600 to be explained later. In the illustration, the supporting shafts 530 represented by a same shape have an equivalent function but the symbols are omitted.

The transmission member 400 has a central aperture 410, and is rotatably fitted in the recessed groove 520 of the base plate 500. It is provided with actuating pins 420 provided in equally divided positions on a circle on the annular plane for causing a rocking motion in the blade members 200, an arm 430 extended toward the supporting portion 540 of the base plate 500, and a slit hole 440 formed in a distal end portion of the arm 430, for fitting with an actuating pin 620 of an actuation lever 600 to be explained later. The blade member 200, employed in plural units (six blades in the illustrated case) is provided, at a proximal end portion, with a fitting hole 210 to be rotatably fitted on the supporting shaft 530 of the base plate 500, a slit hole 220 to be fitted with the actuation pin 420 of the transmission member 400, and, in a distal end portion of each of the blade members to be overlaid as illustrated, a projection 230 for supporting the blade members at a predetermined gap. Members of a shape shown in FIG. 7 have an equivalent function and symbols therefor are omitted.

The pressing plate 100 is formed in an annular shape having, at the center, an optical aperture 110 of a diameter same as that of the optical aperture 510 of the base plate 500, and is provided with mounting portions 120 for mounting to the base plate 500 with a predetermined distance therefrom in order to support and protect the transmission member 400 and the blade members 200 in a rotatable manner with respect to the base plate 500, escape slit holes 130 for the actuating pins 420 of the transmission member 400, and escape holes 140 for the supporting shafts 530 of the base plate 500.

An actuation lever 600 is provided, at an end thereof, with a fitting hole 610 to be fitted and fixed to a supporting shaft 710 of the driving motor 700, and an actuating pin 620 formed at the other distal end, wherein the actuating pin 620 is fitted in the slit hole 440 of the transmission member 400 to transmit the driving power of the motor 700 to the transmission member 400.

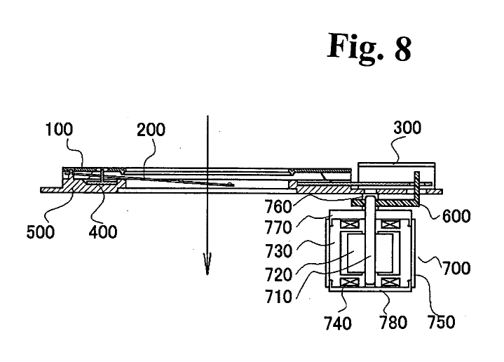

Referring to FIG. 8, the driving motor 700 is constituted of a rotary shaft 710 fitted, at an outside center thereof, with the actuation lever 600, a magnet rotor 720 penetrated by the rotary shaft 710, a coil frame 730 divided in two portions in the lateral or vertical direction and rotatably supporting the magnet rotor 720, a conductive coil 740 wound on the external periphery of the coil frame 730, a yoke 750 for intercepting a magnetic influence with the exterior, cover members 770, 780 and a fixing part 760 integrally formed with the cover member 770 and fixed on the base plate 500. The driving motor 700 may be constituted of various electromagnetic motors, and the illustrated one has an exciting coil wound around the magnet rotor 720 in a direction perpendicular to a direction of magnetic poles thereof, wherein a current is applied to the exciting coil to generate a magnetic field thereby rotating the magnet rotor 720 by a predetermined angle. The rotation takes place clockwise or counterclockwise depending on the direction of the applied current.

It is also possible to wind a driving coil and a braking coil on the coil frame 730 and to apply currents of opposite directions, thereby rotating the rotor by the driving coil and stopping it by the braking coil, and also to embed a photosensor (PH) in one or plural positions of the coil frame 730 to detect the magnetic poles (magnetic field) of the rotor, thereby detecting an angular position of the rotor. Therefore, the blade members 200 can rotate in a predetermined direction by a current supply to the driving coil, under an angular position detection by the photosensor (PH), and can be precisely stopped in a predetermined angular position by a current supply to the braking coil, whereby the light amount is regulated high and low by an aperture defined by the blade members 200.

A protective cover 300 protects a connection, not covered by and exposed from the pressing plate 100, of the arm 430 of the transmission member 400 and the actuating pin 620 of the actuation lever 600, and is mounted, by stopping screws 310, together with the driving motor 700 to the base plate 500.

In the following, an assembling process of the light amount regulating unit, utilizing six blade members as shown in FIG. 7, will be explained. At first, the transmission member 400 is fitted, in a state shown in FIG. 7, into the recessed groove 520 of the base plate 500. Then a first light amount regulating blade A1 of the blade members 200 is fitted, by the fitting hole 210, with the supporting shaft 530 of the base plate 500 in an opposed position, and by the slit hole 220, with the actuating pin 420 of the transmission member 400. Thereafter a second light amount regulating blade A2, a third light amount regulating blade A3, a fourth light amount regulating blade A4, and a fifth light amount regulating blade A5 are overlaid thereon in succession, and a sixth light amount regulating blade A6 is similarly overlaid on the fifth light amount regulating blade A5 in such a manner that a distal end of the blade is positioned under the first light amount regulating blade A1.

More specifically, in the case of utilizing six blade members for light amount regulation as shown in FIG. 7, the first blade A1 is supported at the proximal end thereof on the supporting shaft 530a of the base plate (substrate) 500, with the distal end positioned at the optical aperture 510. Then the second blade A2 is supported on the supporting shaft 530b with the distal end positioned at the optical aperture 510. In this state, an internal edge portion of the second blade A2 is overlaid on an external edge portion of the first blade A1 (cf. FIG. 7). Similarly the third blade A3 is overlaid on the second blade A2, the fourth blade A4 on the third blade A3, and the fifth blade A5 on the fourth blade A4. Finally, as to the sixth blade A6, an internal edge portion is superposed on the fifth blade A5 while an external edge portion is overlaid under the first blade A1. Thus, among the blades overlaid in succession on the first one, a lateral edge portion of the last blade is superposed under the first blade, whereby the plural blades are mutually assembled and enter a coupled state. Therefore, even under an external force such as an impact applied to the apparatus, the blades do not show a fluttering, without a danger of light leaking through a gap between the blades.

Then the pressing plate 100 is mounted thereon with screws 160 in six locations in an illustrated state, thereby completing a light amount regulating unit. Thus the blade members are supported openably/closably (rotatably) between the base plate 500 and the pressing plate 100, and the substrate is formed by the base plate 500 and the pressing plate 100, both being flat members.

An assembling process of the driving motor 700 will be explained with reference to FIG. 8. At first a rotor, integrally formed by an insert molding of the supporting shaft 710 and the sintered magnet rotor 720, is rotatably accommodated in the coil frame 730 which is divided into two portions in the lateral or vertical direction and is provided with the conduction coil 740 wound on an external groove, then the yoke 750 is fitted in a state pinched by the covers 770, 780, and the actuation lever 600 is fitted and fixed in an appropriate position on the supporting shaft 710 thereby completing the driving motor 700.

Then, as shown in FIG. 7, the actuating pin 620 of the actuation lever 600 mounted on the driving motor 700 is fitted in the slit hole 440 of the transmission member 400, positioned on the supporting portion 540, for the driving motor 700, of the base plate 500, and the protective cover 300 is fixed, with the screws 310, from a side of the transmission member 400 opposite to the side to the supporting portion 540, to the base plate 500 together with the fixing portion 760 of the driving motor 700, thereby completing the light amount regulating apparatus E shown in FIG. 8.

At least either of the base plate 500 and the pressing plate 100 is provided with a guide plane for guiding the blade movement, along which the blades execute the opening/closing movement. The guide plane includes a first guide plane formed in a periphery (proximity area) of the supporting shaft and a second guide plane formed on a rim portion of the optical aperture, and a height difference in a direction perpendicular to the direction of the optical path, higher in one side and lower in the other, is formed between the first and second guide planes. Such a height difference can be constructed by forming an inclined flat plane or a step difference on the substrate surface. Consequently each blade executes the opening/closing movement in a position inclined by a predetermined angle to the direction of the optical path.

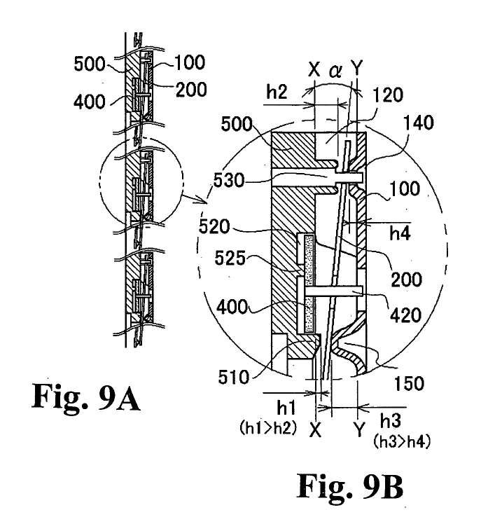

Therefore, in the base plate 500 and the pressing plate 100, either of the first guide plane and the second guide plane is formed higher while the other is formed lower. Referring to FIG. 9B showing the assembled state of the blade member 200, a distal end of the circular rim of the recessed groove 520, defining the optical aperture 510 and coming in contact with the blade member 200, protrudes by a height hi from a reference plane X-X of the base plate 500, while a stepped portion provided in the position where the supporting shaft 530 is fixed and coming in contact with the blade member 200 protrudes by a height h2 (h2>h1) from the reference plane X-X.

On the other hand, a distal end of a limiting protrusion 150, formed by a drawing so as to be opposed to the protruding distal end portion of the circular rim of the base plate 500 coming into contact with the blade member 200, protrudes by a height h3 from a reference plane Y-Y of the pressing plate 100 parallel to the reference plane X-X, while a distal end of an escape hole 140, formed by a drawing so as to engage with the supporting shaft 530, protrudes by a height h4 (h4<h3) from the reference plane Y-Y. An arbitrary plane can be defined by defining three points, and, in this case, a first point for defining the plane of the light amount regulating blade is the stepped portion provided in the position where the supporting shaft 530 is fixed and coming in contact with the blade; a second point is the distal end of the circular rim of the base plate 500, coming in contact with the edge portion of the blade; and a third point is an edge portion of the blade in contact with a plane of a blade in front.

Therefore, the light amount regulating blades constituting the blade members 200 are set on the base plate 500 in inclined positions with respect to the reference plane X-X with respectively different directions of inclination but with a same absolute inclination amount α, and execute rotating operations on respectively different planes. As a result, the six light amount regulating blades constituting the blade members 200 are supported and rotated without a close contact therebetween but with a certain gap though not uniform, thereby drastically reducing a contact portion between the light amount regulating blades and suppressing an operation noise generated by a friction between the closely contacting surfaces of the blades.

In the following, an example of a control circuit for driving the light amount regulating circuit E will be explained with reference to FIG. 11. At first reference is made to FIG. 11 for explaining a circuit structure of a light amount control circuit D for the light amount regulating apparatus E, in which shown are an input terminal IN for a light amount regulation signal outputted from an unillustrated control circuit for the projector; an output terminal OUT for a light amount regulation level signal corresponding to a light amount regulating level of the light amount regulating apparatus E in operation; a voltage +V supplied to the light amount regulating circuit D; a ground terminal G; differential amplifiers Q1-Q3; and a photosensor PH (photoelectric sensor 70) provided in a position opposed to the magnet rotor 720 of the driving motor 700 in the light amount regulating apparatus E shown in FIG. 8 and detecting a light amount regulating position by a magnetic change based on a rotational position of the magnet rotor 720.

Also shown are a driving coil L1 explained in FIG. 8; a braking coil L2; and a capacitor C0 or “by-pass filter (high-pass filter)” provided between the ends of the driving coil L1 for suppressing a change in the driving current to the driving coil L1 immediately after the start of supply thereby reducing the light amount regulating speed of the light amount regulating apparatus E. Other resistors and capacitors may be suitably provided so as to enable a proper operation of the light amount regulating circuit D. In a driving control for the light amount regulating apparatus E, at first a light amount regulation signal for regulating the light amount of an image to be projected is entered from a control circuit of the projector H into the input terminal IN. On the other hand, a light amount regulation level signal of the light amount regulating apparatus E at this point is detected by PH (photoelectric sensor 70), and is amplified and outputted by the differential amplifier Q3.

As a result, the light amount regulation signal and the light amount regulation level signal are compared at a circuit point E1, and, depending on a potential difference thereof, a positive or negative driving current, corresponding to the potential difference of the differential amplifiers Q1 and Q2, is given to the driving coil L1, thereby rotating the driving motor 700 shown in FIG. 8. In this situation, because of a magnetic property changing with the rotation of the magnet rotor 720, a braking current corresponding to such change flows in the braking coil L2 to brake the rotation of the magnet rotor 720 and the detection value of PH (photoelectric sensor 70) varied at the same time, whereby the driving motor 700 terminates rotation at a position where the potential difference at the circuit point E1 is cancelled and the blade members 200 stop at such position.

In such drive, the capacitor C0 or “by-pass filter (high-pass filter)” connected between the ends of the driving coil L1 suppresses an upshift change of the driving current to the driving coil L1. Therefore the driving motor 700 is gradually accelerated immediately after the start of drive, thereby causing the blade members 200 to move gradually and alleviating the operation noise.

In the following a light amount control will be explained in the case in which the above-described light amount regulating apparatus E is applied to the projector apparatus shown in FIG. 5.

The light amount regulating means may execute a control of regulating the light amount according to a brightness in the environment of use, or a control according to a change in the luminance of consecutive projected images. In the former control according to the brightness in the environment of use, an external light is detected by a photoelectric sensor, such as a line sensor or a CCD sensor, provided on the projector apparatus. Such photoelectric sensor may be mounted on an outer casing of the projector for detecting the brightness in the room, or incorporated in the projector for detecting a light reflected from the screen when a test pattern of a predetermined luminance is projected thereon.

Then a light amount regulation is executed based on the light amount electrically detected by the photoelectric sensor. In such regulation, a detection value for example of the external light and a predetermined reference value are compared to calculate regulation value for the light amount in a calculation circuit such as a CPU, and a light amount regulation signal is transmitted to the light amount regulating apparatus. On the other hand, in case of light amount regulation according to the luminance change in the projected images, a luminance is calculated from an image signal transmitted to the aforementioned image forming part and is compared with a reference value, whereby a light amount regulation signal is transmitted to the light amount regulating apparatus.

In the light amount regulating apparatus, currents are applied to the exciting coils (driving coil and braking coil) as described above, whereby the blade members move to a predetermined position. In such a process as that of the present invention, the plural blade members positioned with equal or predetermined distances at the optical aperture of the substrate (base plate and pressing plate) are respectively supported, at the proximal ends thereof, rotatably on the supporting shafts, and rotate along guide planes formed on the substrate. Such rotation causes the distal ends of the blade members to be positioned at the optical aperture, thereby varying the diameter of such aperture. In this operation, since the guide plane is formed as an inclined surface having a height difference or as a step difference, in a direction perpendicular to the direction of optical path, each blade member rotates with an inclination by a predetermined angle to the direction of the optical path.

The present embodiment has been explained on a light amount regulating apparatus E having six blades, but the blade member of the present invention is also applicable to a light amount regulating amount of another constitution, for example a light amount regulating apparatus including a transmission member movably supported on a substrate and outside an optical aperture, and a pair of blade members linked with both the substrate and the transmission member and capable of advancing to or retracting from the optical aperture in the vertical or lateral direction or opening/closing in the light advancing direction thereby regulating the light amount.

Also the blade members 200 are inclined with respect to the transmission member 400, but such inclined positioning is not necessarily required depending on the specifications of the apparatus.

In the present invention, the light shielding heat-resistant sheet material has a constitution of providing a film substrate of a polyethylene naphthalate resin and/or a polyimide resin, on a surface or on both surfaces thereof, with a cured layer of a two-component curable polyester resin paint containing a polyester resin cured with an isocyanate compound and a black pigment, thereby providing following excellent effects:
(1) Firstly, the cured substance of the two-component curable polyester resin paint employed as the coating layer for the polyethylene naphthalate resin and/or polyimide resin provides a high heat resistance, a satisfactory adhesion to the substrate, and a high film hardness. Consequently, in the case of use as a blade member in a light amount regulating apparatus, the coating is difficult to peel by the opening/closing operation;
(2) Also, an immediately effective isocyanate resistant to yellowing such as xylylene diisocyanate (XDI), as the isocyanate compound, causes the two-component curable polyester resin to grow into a high-molecular polymer of a three-dimensional steric structure with a higher molecular weight, thereby realizing a high heat resistance.

Also, the present invention, by employing carbon black as the black pigment, provides the following excellent effects:
(3) Blending of carbon black in the two-component curable resin paint results in a polyester resin film containing a larger amount of carbon black, in comparison with a case of blending carbon black in a polyester resin. In the related-art coating paint, the carbon black content is about 50 wt. % at maximum, since a large addition of carbon black deteriorates the film forming property because of a viscosity decrease in the paint. In contrast, in the two-component curable polyester resin paint employed in the present invention, such content can be made as high as 60-90 wt. %, preferably 75-90 wt. %. Therefore improvements are made possible in the heat resistance, light shielding property, and antistatic property (with a resulting improvement in operation resistance);
(4) A larger amount of carbon black contained in the polyester resin film suppresses a plastic deformation of the sheet material, thereby realizing a heat resistance at a higher temperature range (250° C. or higher); and
(5) In comparison with a case of blending carbon black in a one-component curable polyester resin, the distribution of carbon black in the polyester resin film can be made more uniform, whereby light-shielding spots are not easily formed.

The light shielding heat-resistant sheet material of the present invention can be utilized, in addition to the blade member for use in the light amount regulating apparatus to be incorporated in the projector apparatus for regulating the light amount thereof, as a blade member for use in a light amount regulating apparatus for light shielding in a high temperature environment of about 250° C., for example, for use in an image pickup apparatus to be used in a high-temperature chamber.

The disclosure of Japanese Patent Application No. 2005-184096 filed on Jun. 23, 2005, is incorporated herein.

While the invention has been explained with reference to the specific embodiment of the invention, the explanation is illustrative and the invention is limited only by the appended claims.

What is claimed is:

1. A light shielding heat-resistant sheet material comprising:
a film substrate comprising at least one of a polyethylene naphthalate resin and a polyimide resin; and
a cured layer of a two-component curable polyester resin paint disposed on a surface of the film substrate, the paint comprising a polyester resin, an isocyanate compound as a curing agent, and a black pigment.

2. A light shielding heat-resistant sheet material according to claim 1, wherein the paint layer is disposed on a first surface and a second surface of the film substrate.

3. A light shielding heat-resistant sheet material according to claim 1, wherein the black pigment is carbon black.

4. A light shielding heat-resistant sheet material according to claim 1, wherein the isocyanate compound is xylylene diisocyanate.

5. A light amount regulating apparatus comprising:
a substrate having an optical aperture;
a blade member for regulating an amount of light passing through the optical aperture, the blade member being a light shielding heat-resistant sheet material comprising a cured layer of a two-component curable polyester resin paint containing a polyester resin, an isocyanate compound as a curing agent, and a black pigment; and
a driver for alternately opening and closing the blade member so as to regulate the amount of light.

6. A light amount regulating apparatus according to claim 5, wherein a plurality of blade members is overlaid in succession so as to provide a substantially circular opening at a center of a distal end of the blade members.

7. A light amount regulating apparatus according to claim 6, wherein the plurality of blade members is inclined with respectively different amounts of inclination so as to open and close on respectively different planes.

8. A projector apparatus comprising:
a light source for emitting a light;
a light projector for projecting the emitted light;
the light amount regulating apparatus according to claim 7, the light amount regulating apparatus being provided on the light projector or between the light source and the light projector for regulating an amount of the light issuing therefrom;
an image forming panel for receiving the regulated light; and
a screen for receiving the formed image.
